(19) United States
(12) Patent Application Publication
(10) Pub. No.: US 2008/0009074 A1
(43) Pub. Date: Jan. 10, 2008

(54) Indicator for Multiwell Plate and Method for Using the Same

(76) Inventor: Amos Valinsky, Shilat (IL)

Correspondence Address: SCHWEITZER CORNMAN GROSS & BONDELL LLP, 292 MADISON AVENUE - 19th FLOOR, NEW YORK, NY, 10017, US

(21) Appl. No.: 10/556,741

(22) PCT Filed: May 13, 2004
(86) PCT No.: PCT/IL04/00409

§ 371 Date: Oct. 10, 2006

(30) Foreign Application Priority Data
May 13, 2003 (IL) 155897

(51) Int. Cl. G01N 1/10; G01N 1/00

(52) U.S. Cl. 436/180; 422/58

(57) ABSTRACT

The present invention presents a novel indicator for a multiwell plate (10) having a predetermined array of wells, and a multiwell comprising the same. The indicator comprising a pierceable foil member (20) adapted to cover the top portion of the plate, and an array of signs located on the upper surface of said foil member, adapted to indicate the location of the said array of the wells. The foil is adapted to cover said plate so at least a portion of said array of signs is overlapping said array of wells, so when the foil member is pierced by a means of a pipette (42) at the location of said sign, a noticeable deformation is obtained at the upper surface of said foil member and a clear indication is provided. The present invention is also providing for a method for indicting each sampled well in aforesaid multiwell plate.

### FIELD OF THE INVENTION

The present invention generally relates to an indicator for multiwell plate, more specifically, to a pierceable foil covering the upper portion of the multiwell plate, so that the pipette tip is directed to either puncture or perforate said foil while delivering the sample into each of the wells, thus indicating that the well was filled with said sample. The present invention also relates to a method for using the indictor in every day laboratory practice and to a method for producing the same.

### BACKGROUND OF THE INVENTION

Multi-well plates are widely used in every day laboratory practice for simultaneous processing of discrete quantities of flowable material, especially for the purpose of purification, concentration or extraction of target substances. The plates usually comprise a body with a plurality of receptacles each having an entry end opening for introduction of an individual charge of the flowable material and an exit opening for outflow of at least part of the material. Most of the commercially available multi-well plates are laid out with 96 wells in an 8×12 array (mutually perpendicular 8 and 12 well rows). The dimensions of the aforementioned 96-well plates are standardized. Those plates are typically used as reaction vessels in which various tests and assays are performed. These tedious sampling techniques require a high measure of concentration, for the technician must be aware of the position of the last well sampled.

Such plates usually comprise various auxiliaries and attachments, suitable for the specific laboratory or processing requirements, to be used for positioning the last well sampled. Thus, US Pat. No. 2003,008,412 to Hong et al. presented plate alignment and sample transfer indicia for a multiwell multiplate stack. According to their invention, a first multiwell plate is stacked atop a second multiwell plate. The first multiwell plate has x wells arranged in an array, each well is capable of receiving a sample and has an outlet. The second multiwell plate has y wells arranged in an array, each well being capable of receiving a separate sample. Similarly, GB Pat. No. 2,377,990 to Fischer-Fruhholz et al., introduced an ion exchange or a filtration membrane located on top of the upper portion of the multiwell plate. This thin member is affixed to the body by bonding so as to close the exit openings of the receptacles and form an external face of the device.

It is hence a strong felt need to acquire such a disposable, cost effective indicator, useful for positioning sampled wells in commercially available multiwell plates.

### SUMMARY OF THE INVENTION

It is thus one purpose of the present invention to provide an indicator for a multiwell plate. According to a general embodiment of the present invention, said plate consists of a predetermined array of wells, such as a plate especially adapted for either processing or analyzing enzymatic reactions, or a PCR, ELISA or an FID ninety six wells sampling plate, comprising a configuration of 12×8 array of wells.

The hereto-defined indicator comprising (i) a pierceable foil membrane adapted to cover the top portion of the plate, and (ii) an array of signs or holes, located on the upper surface of said foil member, adapted to indicate the location of the said array of the wells. The aforementioned or perforated foil is further adapted to cover the top of the plate so at least a portion of said array of signs overlaps said array of wells. Moreover, the foil member is characterized by the fact that it is perforated by means of a pipette at the location of said sign, a noticeable indentation is obtained at the upper surface of said foil member, so a clear indication is provided.

The term ‘multiwell plate’ refers in the present invention to any assembly comprising a plurality of about 1 μl to about 1 ml or more wells.

The term ‘pipette’ refers in the present invention to any sampling device, selected, yet not limited to a pipette, tip, injector, syringe, mechanical or electronically driven calibrated pipette, and especially to those pipettes used in every day practice in biochemical, medical or other laboratories, such as Eppendorf pipettes, and most particularly to those pipettes adapted for routine work and extended with a disposable plastic tip.

The term ‘a pierceable foil member’ refers in the present invention to any thin leaf-like sheet easily pierced, punctured, protruded, perforated or penetrated by a means of the pipette, as defined above, or by a tip member extruding from said pipette. It is acknowledged in this respect that said sheet may comprising a plurality of apertures adapted to accommodate the pipette distal tip portion and thus to facilitate the piercing of the sheet by said pipette. The diameter or shape of said pre-pierced apertures is different from that obtained by piercing the sheet. It is further acknowledged that said a pierceable foil member may be incorporated with its frame and/or the multiwell plate as one integrated device

It is according to another embodiment of the present invention, wherein the aforementioned pierceable foil member is surrounded by a frame adapted to fit in size and shape the perimeter of the multiwell plate. According to yet another embodiment of the present invention, the frame is made of metal substances, polymeric compositions or a combination thereof. It is acknowledged in this respect that the frame is either elastic or rigid and may be comprised of various auxiliaries, such as signs (rows and column identification or numeration), attachments (such as a top-cover or an upper screen) etc. It is well in the core of the present invention, wherein the pierceable foil and the attached frame are one integrated disposable product.

It is according to another embodiment of the present invention, wherein the pierceable foil member is made of metallic substances, polymeric compositions or a combination thereof. Most preferably, said pierceable foil member is made of aluminum foil. It is well acknowledged that the foil may be coated by a second layer, such as a lacquer, or alternatively comprised of a multilamenal configuration.

According to another embodiment of the present invention, the pierceable foil member is a perforated foil and hence comprises a plurality of perforations, cuts, holes or bores of any shape and size. Hence, it is in the scope of the present invention wherein the pierceable foil member is a perforated foil, comprising an array of punctures. Moreover, said array is preferably adapted to overlap at least a portion of the array of the wells. It is further acknowledged that for many purposes, the number of the perforations as defined above is equal to the number of the wells. Nevertheless, for a few specific purposes, the number of the perforations is less than the number of the wells, so some of the wells remain intact, sealed and thus are not sampled.

The diameter of the punctures of the perforated foil is preferably equal to or smaller than the diameter of the well's internal bore, so the piercing by the pipette causes a noticeable deformation. The diameter of said puncture may range in the case of commercially available multiwell plates used in routine laboratory practice from about 1 to about 10 mm, preferably about 3 to 4 mm. Hence for example, for a well comprising an internal bore of 1 mm, a puncture with a diameter of 0.5 mm is suitable. According to another embodiment of the present invention, the pierceable foil member comprises at least one tiring line adjacent to the signs, so at the time said foil is pierced, it is tiredtied?? at a predetermined measure, size or shape along said one or more tiring lines. Said tiring lines may be of any shape or size, such as straight-line, circular line, polygonal or star-like shape etc. The tiring lines are obtained by various technological processes, such as pressing metal sheets, LASER-based cutting processes, photochemical etching techniques etc.

The present invention also provides a novel, cost effective and very convenient multiwell plate, especially adapted to routine laboratory practice of sampling comprising the indicator as defined in any of the above.

Furthermore, the present invention provides for an accurate and easy to handle method for indicating each sampled well in a multiwell plate. Said method comprises the following steps: (i) mounting the pierceable foil member on top of the multiwell plate in such a manner that the array of the signs overlaps at least a portion of the array of the wells; subsequently (ii) piercing said foil by a pipette, so the foil is indented in a noticeable manner; and lastly (iii), sampling the well by a means of delivering the sample from the pipette to the inner portion of the well or vice versa. This short and effective method of indications is characterized by the fact that by means of indentation of the foil, each sampled well is effectively indicated. Most importantly, faulty actions of either double sampling or abstained sampling are thus completely avoided.

### BRIEF DESCRIPTION OF THE INVENTION

In order to understand the invention and to see how it may be carried out in practice, a preferred embodiment will now be described, by way of non-limiting example only, with reference to the accompanying drawing, in which

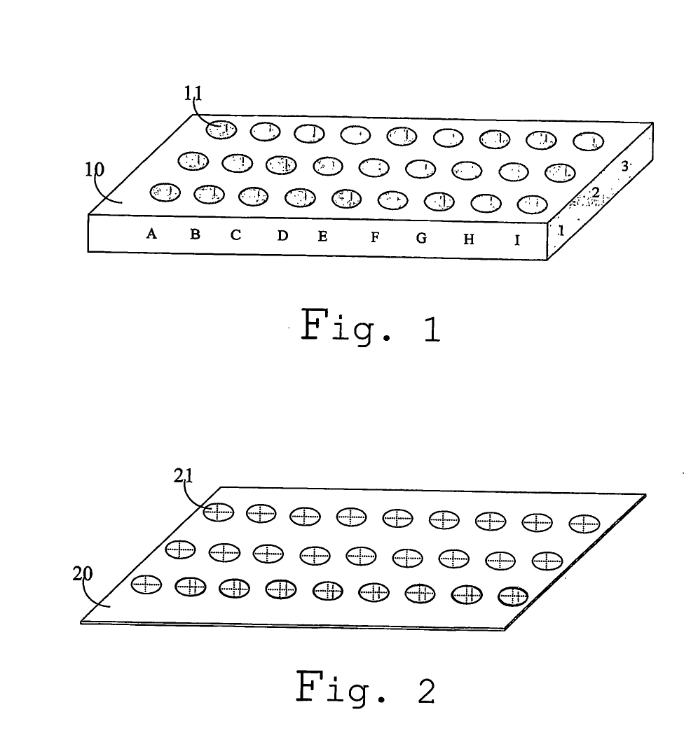

FIG. 1 schematically presents a perspective view of a commercially available multiwell plate;

FIG. 2 schematically presents a perspective view of a pierceable foil member according to one embodiment of the present invention;

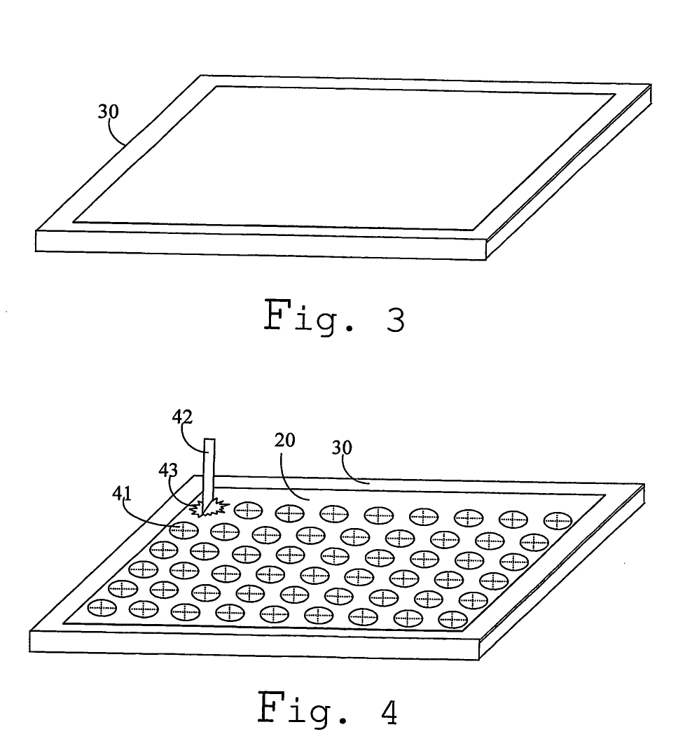

FIG. 3 schematically presents a perspective view of a frame according to another embodiment of the present invention;

FIG. 4 schematically presents a perspective view of a frame and a pierceable foil member according to another embodiment of the present invention;

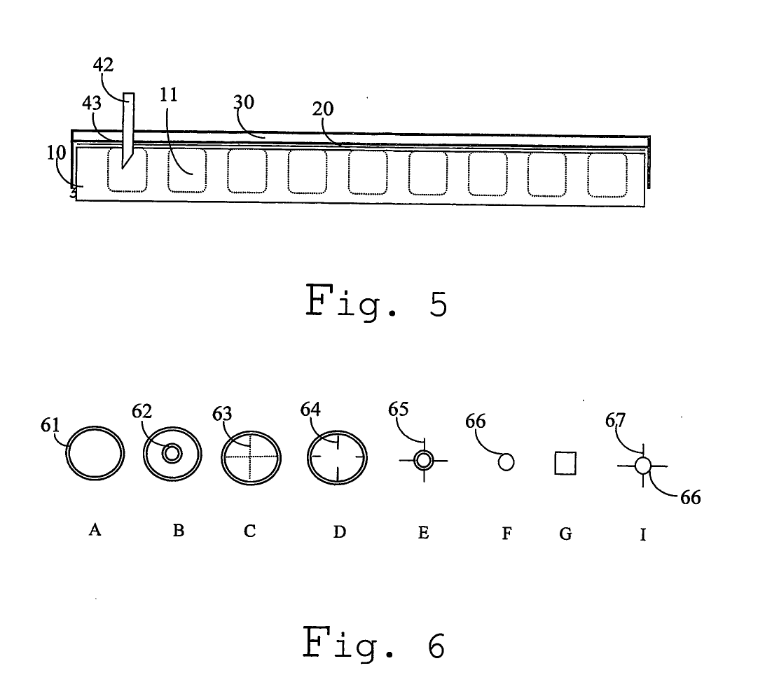

FIG. 5 schematically presents a lateral cross-section of a commercially available multiwell plate, covered by pierceable foil member in a frame according to another embodiment of the present invention; and

FIG. 6 schematically presents a top view of a pierceable foil member and the signs located on its top surface according to yet another embodiment of the present invention.

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide an indicator, especially useful for avoiding faulty actions of either double sampling or abstained sampling.

Reference is thus made to FIG. 1, presenting a schematic illustration of a multiwell plate (10), comprising a 9×3 array of wells, such as well (11). Rows and columns are indicated by letter (here: A to I) combined with a number (here: 1-3). And signs by number

Reference is made now to FIG. 2, presenting a schematic illustration of a pierceable foil member (20), comprising the hereto-defined 9×3 array of signs. Each sign is characterized here by a circular draw??? and an X-like indication (See for example sign 21, located in the A-3 position in the aforementioned array.

It is yet further acknowledged in this respect that according to one especially preferable embodiment of the present invention, the indicator for a multiwell plate is comprised of a pierceable foil, which comprises an array of previously produced punctures, wherein said punctures are smaller in diameter than the diameter of the bore, so while delivering the sample by a suitable pipette, the tip portion of the pipette indents the foil (namely, increasing the diameter of the said puncture) in a noticeable manner.

Reference is made now to FIG. 3, presenting a schematic illustration of the frame (30), in a perspective view, which does not include the attached pierceable foil member (20). It is hence acknowledged that frame (30) is adapted to fit the top portion of plate (10) and thus to effectively anchor foil (20) on top of plate (10) in the desired overlapping orientation

Reference is made now to FIG. 4, presenting a perspective schematic illustration of the frame (30), and the attached pierceable foil member (20). The pierceable foil member comprises a plurality of signs, adapted to overlap a 9×6 array of wells. Intact sign (see 41 for example) are characterized by a circular draw??? and a central X-like indication. The tip portion of a pipette (42) pierces sign (43), which corresponds to well number A-6 (not shown), and indents the foil irreversibly, to obtain a star-like tiring pattern on the foil.

Reference is made now to FIG. 5, presenting a schematic lateral cross-section illustration of the plate (10), the pierceable foil member (dark line, 20) and the frame (30). Plate (10) is comprised of 9 wells in a row, such as indicated well (11). The tip portion of the pipette (42) pierces the foil member (20) in such a manner that the tip is located inside the inner portion of the well. When penetrating through the foil (20), a irreversible and noticeable indentation is obtained in the area (43) located adjacent to the tip (42).

Reference is made now to FIG. 6, presenting a schematic top view of various embodiments of the pierceable foil member (20). Hence, a circular drawn line is presented in view 6A, and a doubled line structure is presented in view 6B. An X-like pattern is described in view 6C.

A circular drawn pattern is provided in view 6D. This pattern is accompanied by a plurality of tiring lines (64), located inside the perimeter of the drawn circle. View 6E shows the same, wherein the tiring line extrudes outside the small and central drawn line.

A round preformatted puncture (66) is presented in view 6F. According to this preferred embodiment of the present invention, the piercing of the foil (20) is both easy and fast, and fine enlargement of the newly made hole's diameter is easily obtained. Similarly, a polygonal shape (here, squared pattern) preformatted puncture is presented in view 6G.

It is well in the scope of the present invention wherein a combination of these embodiments is provided. Thus for example, a round preformatted puncture (66) is provided together with a plurality of tiring lines (67) as presented in view 6F. Other embodiments, such as a combination of drawing patterns, preformatted punctures and tiring lines are also possible.

1. An indicator for a multiwell plate consisting of a predetermined array of wells, said indicator comprising
a. a pierceable foil member adapted to cover the top portion of the plate;
b. an array of signs located on the upper surface of said foil member, adapted to indicate the location of the said array of the wells;
wherein said foil is adapted to cover said plate so at least a portion of said array of signs overlaps said array of wells, so when the foil member is pierced by a means of a pipette at the location of said sign, a noticeable indentation is obtained at the upper surface of said foil member and a clear indication is provided.

2. The indicator according to claim 1, wherein the pierceable foil member is surrounded by a frame adapted to fit in size and shape the perimeter of the multiwell plate.

3. The indicator according to claim 2, wherein the frame is made of metal substances, polymeric compositions or a combination thereof.

4. The indicator according to claim 2, wherein the frame is either elastic or rigid.

5. The indicator according to claim 1, wherein the pierceable foil member is made of metallic substances, polymeric compositions or a combination thereof.

6. The indicator according to claim 5, wherein the pierceable foil member is made of aluminum foil.

7. The indicator according to claim 1, wherein the pierceable foil member is a perforated foil.

8. The indicator according to claim 7, wherein the pierceable foil member is a perforated foil, comprising an array of punctures; said may is adapted to overlap at least a portion of the array of the wells.

9. The indicator according to claim 8, wherein the diameter of the punctures of the perforated foil is smaller than the diameter of the well's internal bore.

10. The indicator according to claim 1, wherein the pierceable foil member comprises at least one tiring line adjacent to the signs, so at the time said foil is pierced, it is tired at a predetermined measure, size or shape along said one or more tiring lines.

11. The indicator according to claim 1 as described in FIG. 2.

12. The indicator according to claim 2 as described in FIG. 4.

13. The indicator according to claim 1, comprising one or more of the signs described in FIG. 6.

14. A multiwell plate comprising the indicator as defined in claim 1.

15. A method for indicating each sampled well in a multiwell plate comprising;
a. mounting the pierceable foil member on top of the multiwell plate in such a manner that the array of the signs overlaps at least a portion of the array of the wells;
b. piercing said foil by a pipette, so the foil is indented in a noticeable manner; and
c. sampling the well by a means of delivering the sample from the pipette to the inner portion of the well or vice versa;
characterized in that by said indentation of the foil, each sampled well is effectively indicated and faulty actions of either double sampling or abstained sampling are avoided.
